(19) United States
(12) Patent Application Publication
(10) Pub. No.: US 2002/0166127 A1
(43) Pub. Date: Nov. 7, 2002

(54) System and method for providing advertisements in a wireless terminal

(75) Inventors: Hiroaki Hamano, Foster City, CA (US); Kenji Takeda, Palo Alto, CA (US); Jack Selig Fuhrer, Scottsdale, AZ (US)

Correspondence Address: David T. Cunningham, Esq., Hitachi America, Ltd., 50 Prospect Avenue, Tarrytown, NY, 10591, US

(73) Assignee: Hitachi America, Ltd.

(21) Appl. No.: 09/736,009

(22) Filed: Dec. 13, 2000

Related U.S. Application Data
(60) Provisional application No. 60/170,811, filed on Dec. 15, 1999.

(51) Int. Cl. H04N 7/025; H04N 7/10; H04N 7/173

(52) U.S. Cl. 725/105

(57) ABSTRACT

A system and method for providing advertisements to a wireless remote display terminal. The terminal may display Internet web sites and other data while a viewer is also watching a television channel or performing other tasks. For example, a home entertainment center can include a television and an additional remote display terminal. Viewers can access information related to the television program on the remote display terminal. When the remote display terminal is turned on, a personalized advertisement is displayed to the viewer during the initialization process. The advertisement revenues can help offset the cost of the remote terminal to the viewer. The advertisements can be targeted to particular users by matching the advertisements to personal information obtained by surveys, past viewing and Internet history or third party sources such as magazine subscriptions.

### RELATED APPLICATION

This application claims the benefit of U.S. Provisional Application Serial No. 60/170,811, entitled “System and Method for Proving Advertisements in a Home Entertainment Center”, by Hamano et al., filed on Dec. 15, 1999.

### FIELD OF THE INVENTION

The present invention relates to wireless terminals, and more particularly, to systems and methods for providing advertisements on a wireless display terminal including advertisements that can be transmitted from a set top box.

### BACKGROUND OF THE INVENTION

The Internet has become an inexpensive and easy way of communicating within the United States and around the world. A user of the Internet will typically access the Internet from a home computer through the use of a web browser. In a common configuration, a home computer is connected to a modem that dials a server via telephone lines. For example, the modem will dial a local access telephone number to connect to the server which can then in turn connect with other servers which form part of the Internet.

Recently, in addition to accessing Internet servers via telephone lines, users are able to access the Internet via cable transmission lines. Thus a set top box that receives the signals from cable operators and connects to a television set or monitor can also receive and send Internet messages and data. Cable transmissions can have a larger bandwidth in order to transmit information faster than standard telephone lines.

While set top boxes were traditionally used simply as a receiver of television signals, they can also be adapted to connect to computers so that a viewer can send and receive messages to and from the cable operator by using the computer. The computer can also be linked to the Internet, either separately or though the set top box, so that the user can view a related web site while watching a television program. The combination of viewing the cable television signal and Internet access can have powerful results in both the entertainment and education areas.

Many people have their home computer located in another room away from their television set that is connected to the set top box. Even if the television and computer are located in the same room, it may be difficult to view both screens at the same time to see both a television program and the Internet due to the connecting cables and size of the devices. Thus, a wireless connection between a small mobile Internet display device and the set top box connected to an Internet Service Provider would be beneficial.

While many people who have cable television and set top boxes desire Internet access on a second display, a remote mobile display terminal that receives, processes and displays the Internet information can be relatively expensive. Some companies have attempted to reduce the price of stand alone Internet hardware by requiring users to constantly view advertising on the display. Typically, the advertisements will be continuously shown on a portion of the display and can be distracting and annoying to the viewer.

A new way of providing advertising information that is more selective, efficient and user friendly is needed in home entertainment centers and to wireless terminals. The technique should also preferably take advantage of the interactive set top box/remote display terminal combination. In addition, it would be advantageous to apply the new advertising system and method to other wireless terminal applications such as cellular phones or personal digital assistants.

### SUMMARY OF THE INVENTION

The present invention relates to a system and method for providing advertisements to a wireless display terminal, e.g., in a home entertainment center. In one embodiment, the inventive method includes the steps of selecting advertising information related to at least one user of a remote terminal provided by a cable/satellite operator; transmitting the selected advertising information from a set top box to the remote display terminal that displays, e.g., images and web sites obtained on the Internet, and displaying the selected advertisements while the remote terminal is being initialized during power up or during another operation. In another embodiment of the invention, the selected advertisements are displayed when the web browser function on the remote terminal is selected. In addition to displaying selected advertisements, general advertisements can also be transmitted and displayed. The remote terminals can also receive the advertising information from other sources such as a satellite transmission.

The selection of advertisements can be made based on personalized information of one or more users of the remote terminal. The information can be selected based on surveys that are completed by the user, past history of Internet or cable television usage of the user or other third party sources such as magazine subscriptions. In addition, information can be obtained from the usage of the remote terminal for other functions. The selection process can occur at the set top box, the cable operator's or other transmission operator's server or the remote terminal.

### BRIEF DESCRIPTION OF THE DRAWINGS

The objects, features and advantages of the present invention will become more apparent from the consideration of the following detailed description, taken in conjunction with the accompanying drawings, in which:

FIG. 1 illustrates the system in accordance with one embodiment of the invention including an Internet Server, a set top box and a remote Internet terminal;

FIG. 2 illustrates a flow chart of the steps performed by the remote Internet terminal for retrieving and displaying the targeted advertisements;

FIG. 3 illustrates a flow chart of the steps performed by the set top box for retrieving and transmitting the targeted advertisements;

FIG. 4 illustrates a block diagram of the remote display terminal;

FIG. 5 illustrates an example of a targeted advertisement displayed on the remote terminal;

FIG. 6 illustrates a remote terminal display showing available user functions;

FIG. 7 illustrates an alternate display site for the advertisements; and

FIG. 8 illustrates a flow chart of the steps for completing a purchase transaction in response to the advertisements.

### DETAILED DESCRIPTION OF THE PREFERRED EMBODIMENT

Wireless terminals are becoming more and more sophisticated and complex. Wireless terminals include devices such as personal digital assistants, cellular phones, Internet Appliances, automobile displays or personal computers. One example of a use for wireless terminals is in a home entertainment center. With the Internet becoming an emerging entertainment and economic force, the concept of a home entertainment center has expanded beyond the television and stereo and now includes Internet access and display. Residential gateways now enable a viewer to receive and interact with many different sources of information including television programming and Internet information. There are many beneficial ways to use the Internet simultaneously with television programs. For example, a user could look up the recipe while viewing a cooking show, look up music for background information or karaoke or use a program menu to select programs.

The cost of the hardware and software for providing Internet service as well as television service is relatively high. While many customers can rent such equipment from the cable operator, if the cost is too high, it may be prohibitive for many consumers.

One way to reduce the cost to the consumer is by showing paid advertisements to the consumers. One characteristic of wireless remote terminals for displaying Internet web sites is that they typically are battery powered so they can be easily moved as needed. In order to conserve battery power between charges, many users turn the remote terminals off when they are not in use. Thus, if someone is watching three hours of television programming one evening, they may turn the remote terminal on and off several times. This feature of repeatedly turning a terminal off and on creates a unique advertising opportunity.

In order to be able to obtain advertising revenue in a more user friendly manner, the remote display terminal start up screen can be used to display advertising during a period of time while the terminal is “booting up.” Typically, the operating system or computer manufacturer will display their own company or product name during that period. However, advertisements can also be displayed during the start up period. The advertisements can also be personalized to the particular user by using a variety of techniques.

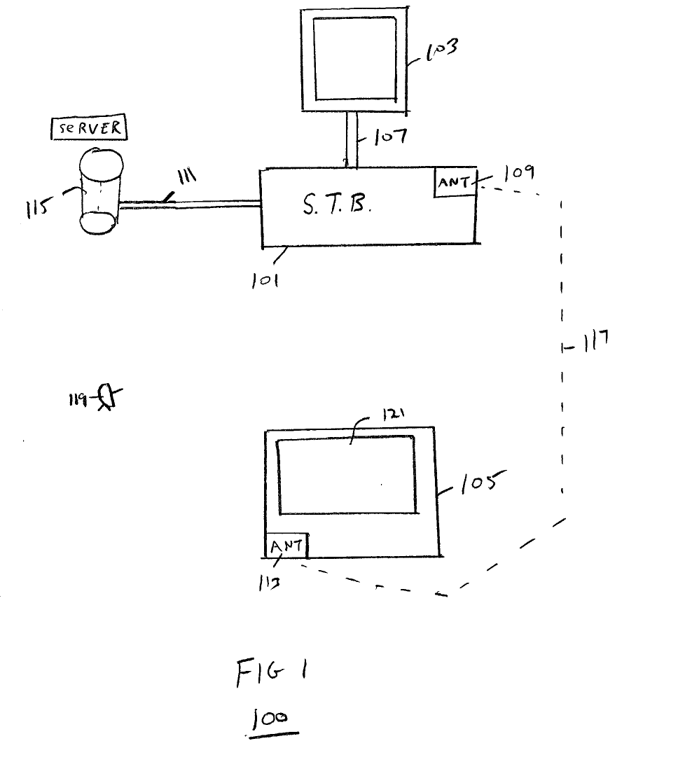

FIG. 1 shows a block diagram of a home entertainment system using targeted advertising. System 100 includes a set top box 101, a display 103, a remote display terminal 105, a server computer 115 and a remote transmitter 119. Set top box 101 includes a transmitter 109 for transmitting information in a wireless manner to remote terminal 105. Transmitter 109 can use different wireless technologies such as Bluetooth wireless technology. Set top box 101 can be any type of device containing a microprocessor. Set top box 101 is connected to a data processing server 115 via cable 111. The link between the set top box 101 and the server 115 can also be wireless, such as a satellite transmission. Set top box 101 is also connected to a display 103 via cable 107. The link between the set top box 101 and the display 103 can also be wireless. Display 103 can be any form of display, for example, a conventional television display or a flat panel display, etc.

Remote display terminal 105 is a device that includes a microprocessor and transmitter/receiver antenna 113. Remote display terminal 105 preferably contains a display 121 but can also be connected to an external display device. Remote display terminal 105 could be a Hitachi manufactured ePlate™ hand held computer. Remote display terminal 105 communicates with set top box 101 in a wireless mode. Transmitter/receiver 113 can also communicate directly with remote transmitter 119 in an alternative embodiment instead of or in conjunction with the set top box. Remote transmitter 119 can be, for example, a satellite transmitter or land based transmitter.

In order to display advertising information at the remote display terminal 105, advertising information is transmitted from set top box 101 to remote display terminal 105. The transmission preferably is triggered when the remote display terminal 105 is turned on by the user. A request is sent by the remote display terminal 105 to the set top box 109 requesting the transmission of the advertising information. Alternatively, the set top box can determine if the remote display terminal is operating and transmits the information automatically. Moreover, the set top box can continuously transmit advertising data when turned on and the remote display terminal can receive and process the data when activated.

The advertising information can also be received from a remote transmitter 119. For example, if remote transmitter 119 is a satellite, it can continuously transmit advertising information and the remote display terminal 105 can filter the information for the advertisements pertinent to the user. One such filtering system is described in U.S. Pat. No. 5,617,565, entitled “Broadcast Interactive Multimedia System” assigned to Hitachi America, Inc. (which is hereby incorporate by reference).

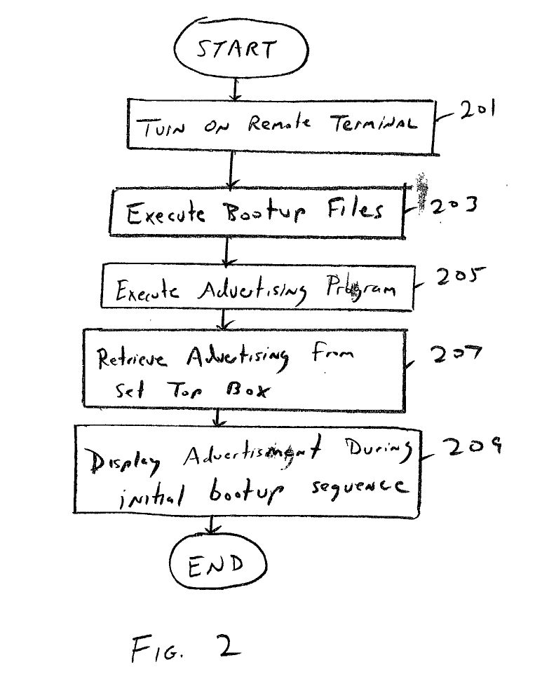

In an alternative embodiment, the advertising information can be obtained during the previous time the remote display terminal was activated and stored in memory in the remote terminal display. While the advertising information would not be as current as in the case of obtaining new information, the transmission receiving and processing steps would not be needed to be performed initially and the information would be near current depending upon the usage history of the remote terminal display. A test could be performed to determine how current the advertising information was. If it was not sufficiently current, it could be update as described in FIG. 2.

FIG. 2 is a flow chart of the steps performed by the remote display terminal to retrieve and display the targeted or personalized advertisements. Step 201 powers up the remote display terminal. This step can be performed, for example, by activating a power switch on the remote display terminal. In an alternative embodiment, the remote display terminal can be previously placed in a “sleep mode” which turns the display screen off to save battery power. If the user presses any key, the remote display terminal “wakes up” and displays the screen. The act of “waking up” can also be considered a power up function for the techniques described in this application.

Step 203 executes a file during the “boot up” sequence. When a remote display terminal is turned on, it executes a number of boot up programs to initialize and start the operating system. One of the files that can be executed can be a display advertisement program. Alternatively, a display advertisement program or subroutine can be executed during the “wake up” sequence.

Step 205 executes the advertisement program. The advertisement program can be, for example, written in C programming language or any other programming language. It can also be previously assembled and stored in machine code in the remote display terminal to speed up its execution time. Moreover, it can also be stored as a subroutine in the operating system.

Step 207 retrieves the advertisement data from the set top box. In order to ensure that current advertisements are displayed, the remote display terminal will communicate with the set top box to retrieve current advertisement data. The communication can occur by wireless transmission, by cable or by any other transmission means. Alternatively, the advertisement information can come from another remote source, such as a satellite transmitter. Additionally, the advertising information can be accessed from memory in the remote terminal and the information can be updated on a periodic basis.

It is important that the advertising information be current because some of the advertisements can be date and time sensitive. For example, a local department store may be having a three-day sale and want to display advertisements for that sale only during the week prior to the sale. Another example may be an advertisement for a television program being displayed at a certain time on a particular day. The advertising information can be supplied by the cable or satellite operator on a continuous basis to the set top boxes to ensure the advertising data is current.

In an alternative embodiment, the remote display terminal can collect the advertising information if and when the terminal connects to the Internet. In this embodiment, the remote display terminal will preferably have sufficient processing power and web browser software to support Internet operations. Information can be sent to the remote display terminal based on the web sites the user visits or on its web history from a file tracking where the user visited on the Internet. The advertising information would then be stored locally in the memory of the remote display terminal so that the next time the terminal was powered up, the advertising information would be displayed.

Step 209 displays the advertisement during the booting up process. When a remote display terminal is powered up, a number of programs or subroutines are executed to initialize, load and execute background functions necessary or helpful to the terminal's operation. For example, the operating system typically displays icons of programs that are available to be run. Other programs may be a printer (or other periphery) initialization sequence or a virus scan. During this time, typically the name of the operating system company is displayed by a terminal. Most users simply wait for the initialization time until the remote display terminal is ready to be used. The initialization time can take 5 seconds, 15 seconds, 30 seconds or even up to a minute or more depending upon how the terminal is configured. In accordance with the invention, the screen can show a timely advertisement during this down time. This allows the user to view advertisement information that may help the user acquire goods or services at discounts in the case of a sale. Or the user may obtain information regarding a television program that he may wish to view. The advertisements can also be personalized to the viewer.

The advertisements also help the service providers by receiving advertising revenue from the merchants placing the advertisements. From the merchant's point of view, their advertisements are reaching the correct audience and thus are more effective. If a user voluntarily provides information which can be used to further tailor the advertisements to the user, then the user may receive a special discount on the remote terminal because the ads will be more effective, and thus the service provider can charge more.

While displaying the advertisements is very beneficial during the “boot up” period, the advertisements can also be displayed if the remote display terminal is “woken up” in response to an external stimulus such as a key being hit or the mouse button pushed or if the user activates the web browser icon. At these times, there is a short delay while the programs are loading and executing before the user can interact on the Internet. During this delay, the user can be informed, for example, about a new or improved web site or about an on-line interview occurring or soon to start. The advertisements can also be displayed while the remote display terminal is on but is not being currently used; e.g., as a screen saver.

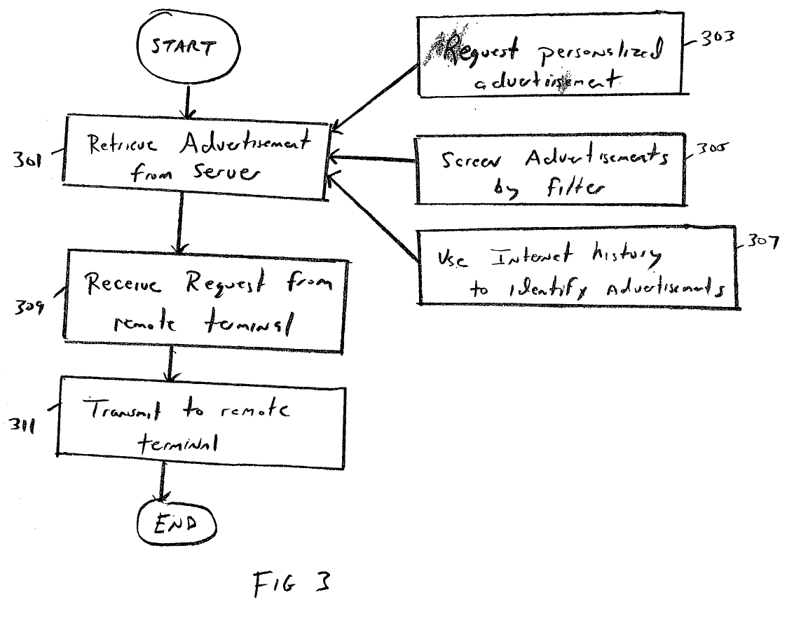

FIG. 3 is a flow chart of the method for the set top box retrieving and transmitting the advertising information to the remote terminal. Step 301 retrieves the advertising information from the cable operator. The set top box is connected to a cable or satellite operator that transmits the programming information. The cable operator can also provide access to a server for Internet access. The connection between the set top box and cable satellite operator can be, for example, by physical cable or by satellite link. Some cable operators can also send additional information either as part of the transmission stream or as a separate message. The advertisement information can be sent in a number of ways. Some examples are shown in steps 303, 305 and 307. Step 305 is the preferred embodiment. One of these three steps may be used to retrieve the advertising information.

In step 303, the set top box requests a personalized advertisement from the cable operator. The set top box can send a message including a unique identifier of the customer so that the cable operator can access a database and transmit advertising information that is related to the desires or habits of the user. The preference information can be obtained, for example, by an on-line survey completed by the user, based on a history of the web sites visited, or other data obtained, for example, from third parties such as magazine subscriptions. For example, someone getting baby magazines may receive baby-related advertisements and someone receiving a home repair magazine may receive home-related advertisements. The step top box can also send a profile of personalized information, such as the last five web sites visited or programs watched, to the service provider who can perform the filtering operation at the server. A consumer may find it beneficial to provide information regarding his favorite stores or web sites so that he may receive electronic coupons, special offer notices or information about relevant sales. The personalized advertisements allow the merchant to reach potential buyers and also allow the customers to potentially save money.

Step 305 is an alternative way of retrieving advertising information tailored to the user. In step 305, the cable operator is continuously sending advertisement information in its data stream. The set top box then acts to filter the advertisement information to select the most relevant advertisements. The filtering can be based, for example, on characteristic data attached to the advertising information or on key working the advertisements. The filtering process can be performed by the on board microprocessor on the set top box. Alternatively, the set top box can accept the general advertisements being transmitted and transmit them to the remote display terminal for display. The remote display unit can also filter the advertising information itself.

Step 307 is yet another way of retrieving advertising information tailored to the user. In step 307, an access Internet “history” can be used to help determine the most relevant advertisements at the set top box. If a history is present, either through the web browser or otherwise, it can be used to help filter the information being received by the cable operator. The web sites in the history can be categorized and be used as the filter data. If there is no history present, a default advertisement can used.

The advertisement can alternatively be targeted by the zip code of the user or other known attributes of the user (e.g., sex, age, etc.). The zip code or other information can be obtained from a warranty registration card, by a survey or by third party collected information (such as a telephone and address directory). The advertisements can also be randomly chosen from a carousel of advertisements. The advertisements could be a mixture of targeted local ads and more general national ads (e.g. for nationally branded colas).

The set top box stores the current targeted advertisements so that it can retrieve and send the advertisement when requested by the remote display terminal. If a user does not want his attributes to be used for personalizing the advertisements, a standard advertisement can be used, such as a national brand.

Step 309 receives a request for a personalized advertisement from the remote display terminal. The request is preferably sent in a wireless manner by the remote display terminal during its power up operation. The set top box then transmits the advertising information that has been targeted to the user to the remote display terminal via wireless transmission in Step 311. Alternatively, the remote terminal can be connected to the set top box by cable.

In an alternative embodiment, the set top box can be continuously sending the advertising information so that the remote terminal need only receive the advertising data when required. In another alternative embodiment, the remote display terminal can perform the advertisement selection process itself and be connected to the cable operator directly via a remote transmitter.

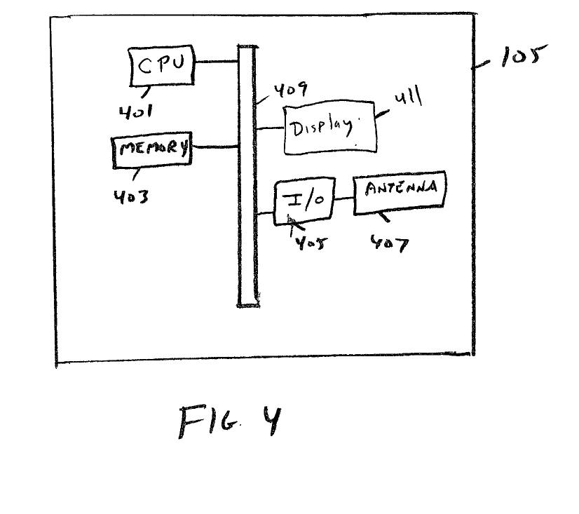

FIG. 4 illustrates a block diagram of the remote display terminal 105 used in accordance with the invention. The remote display terminal includes a microprocessor 401, a memory 403, input/output mechanism 405, antenna 407, display 411 and a data bus 409. Microprocessor 401 executes the instructions for displaying the advertisements. Memory 403 stores the advertising information to be displayed. I/O mechanism 405 receives and transmits data including, for example, the requests for advertisement data and the advertising data itself. Wireless antenna 407 is used in the wireless transmission/reception of data. Display 411 displays the advertisements and other information and can be separately connected to the terminal. Data bus 409 connects the internal components.

The advertising data can be sent in ASCII text form, video format, audio format, MPEG format, or any other format. The data can contain both video and audio components. The remote display terminal can enhance the advertising data with software tools such as background or color selections or simply display the data. Memory 403 can include a Flash Ram for display of the advertisement during the bootup sequence.

The remote display terminal communicates with the set top box when accessing the Internet or communicating with the cable operator/server. The set top box preferably acts as the client for the web server and transmits the information to the remote display terminal. The remote display terminal acts as a user interface but allows the set top box to be directly converted to the server. The set top box can display televised shows and concurrently communicate with the remote display terminal.

In an alternative embodiment, the remote display terminal can act as the client to the web server and simply pass the information to the set top box that acts a conduit of information. The set top box may perform minimal operations such as security protocol for the communicated information.

The remote display terminal can be a hand held computer, a personal digital assistant, an Internet appliance, an automobile mobile terminal, a cellular phone or any other device with a display.

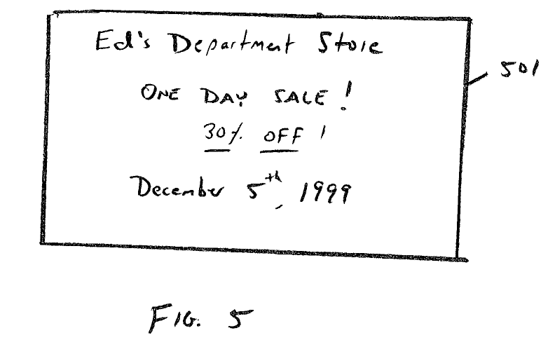

FIG. 5 shows an example of an advertisement that can be displayed on the remote display terminal during the bootup process. Screen 501 shows an advertisement for a department store near to the user. The date of the sale can typically be, for example, the date when displayed or 10 or so days in advance of the sales. The advertisements can also be in the form of a coupon which can printed out by the user. The example in FIG. 5 is not meant to limit the invention in any manner.

The remote display terminal that communicates with the set top box can have additional benefits. Besides advertisement data, other data can be transmitted to the remote terminal. For example, television programming information can be transmitted so that a program menu can be displayed on the remote terminal. The program menu can be personalized by the user to only display the time, channels or subject matter that the user wants to view. Thus a user could display a sports menu that only includes available sports programs and events.

In the above example, the personalized advertisements could be related to the programs selected for the program menu. If mostly sports channels are selected, then the advertisements displayed could be sports related such as ads for sports equipment, sports tickets or sports Internet sites. The data relating to the menu information could be stored in the set top box, the remote display terminal or in a server database. One way to select related advertisement information would be the following:

1) characterize each channel selected for the menu (e.g., sports, current news, movies);

2) identify the characteristic with most selected channels, such as sports; and

3) use the most selected characteristic as the advertising characteristic for the filtering operation.

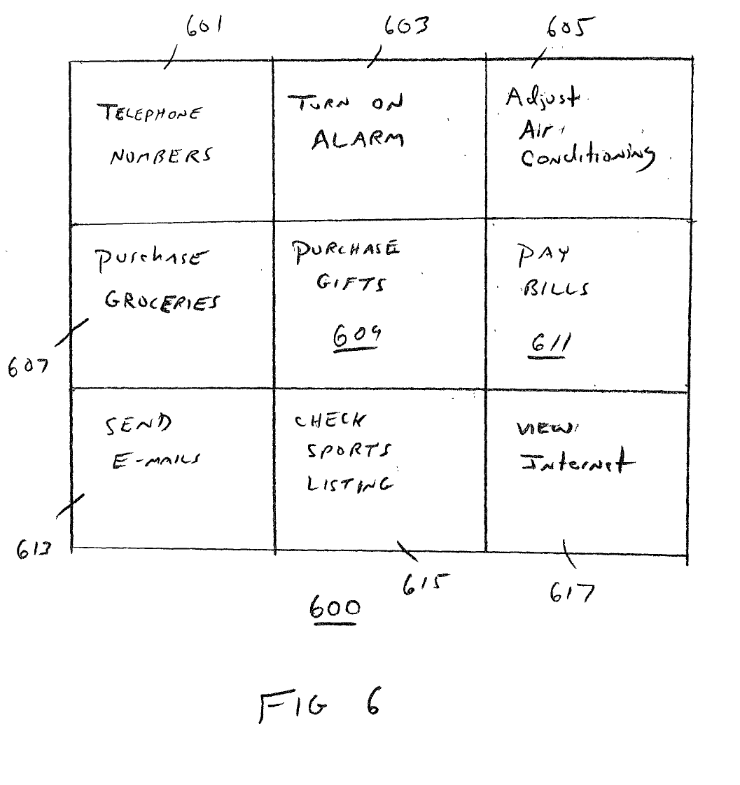

FIG. 6 is a graphic representation 600 of an example of a remote display terminal's display showing some of the user functions that can be initiated by the remote display terminal 100. The functions can be activated by a touch screen, by a keyboard that is incorporated or attached to the terminal, by voice activation or by some other means. The selective advertisements can be further personalized by using information related to which functions are activated and how often they are used. The frequency of use data can be stored in the memory in the terminal or in the set top box. For example, if a telephone directory function 601 is frequently activated, then telephone carrier advertisements may be more relevant to the user. If the remote terminal is a cellular phone, information about where the calls are placed could be used to help match the advertisements or an individualized advertisement based on calling patterns could be created, e.g., the cheapest phone plan for the caller could be brought to the caller's attention.

Another example of a possible function is “Turn on Alarm” 603. This function allows the user to remotely turn on his house security system. Frequent use of this function may indicate that the user is security conscious and may be interested in other security type products or services. The “Adjust Air Conditioning” 605 function indicates the user has a air conditioner and may need filters or a new unit. Other home automation functions could be adjusting the lighting or adjusting the volume of a stereo or television. The “Purchase Groceries” 607 function allows the advertisers to key advertisements or electronic coupons for foods and other products that the consumer will likely buy. Thus the merchant and consumer benefit from receiving information that may save the user money while increasing sales of the merchant.

The function “purchase gifts” 609 also allows advertisers to send the user advertisements for products that are similar to the type of gift chosen. The function “Pay Bills” 611 can provide information about other types of merchants or suppliers with which the user is doing business. The function “Send E-mails” 613 can also indicate what businesses the user is communicating with to transact business. Another example is “Check Sports Listing” 615. The sports television listing, for example, can in some cases be customized by the user and will indicate what types of sports the user is interested in. A user who frequently checks the sports listing also indicates a general interest in sports and sports related products and services. A “View Internet” function 617 is also shown.

The display of the remote display terminal shown in FIG. 6 can be configured to show all, some or none of the functions listed in the example. The example shows, however, how the particular use of the remote display terminal is indicative of the preferences and interests of the user or users of the terminal. The mere selection of particular functions to be displayed can also be used to personalize the advertisements. If a user is uncomfortable with advertisers receiving such personal use information, the data collection and advertising personalization process can be done on the remote display terminal itself or in the user's set top box. Alternatively, the user can elect to receive only general advertisements or authorize only some of the information to be provided such as their town. However, personalized advertising benefits the consumer as well as the merchants in that the advertisements received will be most relevant to the user.

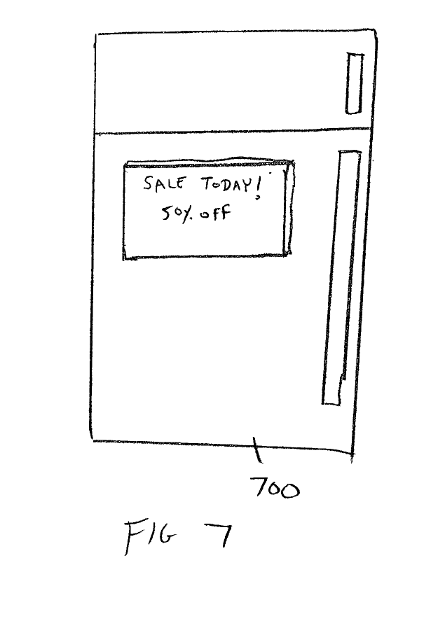

FIG. 7 shows an alternative display area for the advertisements. Refrigerator 700 can be equipped with a flat panel screen for displaying such things as a family organizing calendar, a grocery list, digital photographs, etc., as well as the advertisements. The remote display terminal could be attached to the appliance by, for example, magnets connected to the remote display terminal. Alternatively, the advertisements could also be sent from the remote display terminal to the screen on the appliance. Thus, periodically, the advertisements could be displayed on the screen showing an ongoing sale. The screen could alternatively be located on a wall, in a car or anywhere else the user may view the screen.

In addition to displaying the advertisements, the user could also perform a function in response to the advertisement such as initiate the purchasing of the advertised product or service. For example, if the advertisement showed a camera for sale, the user could press the terminal's keypad or screen to initiate the purchase of the camera. The users shipping and billing information can all be previously stored in the terminal or set top box so the purchase could be made very quickly. Alternatively, the user could enter the necessary transaction information into the terminal or set top box for the purchase transaction.

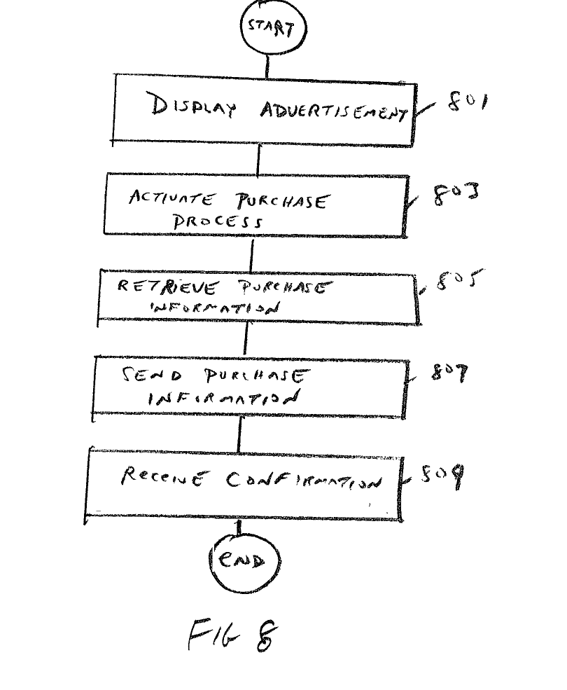

FIG. 8 is a flow chart of the steps for performing a purchase transaction in response to the advertisements. Step 801 displays the advertisements in accordance with the invention. In step 803, the user then activates the purchase process by, for example, hitting a key on the remote display terminal, touching the screen in the case of a touch screen device, giving a voice command if the terminal is capable of processing such a command or by any other means. Once the command is received by the remote display terminal, it executes a program or subroutine to start the transaction. The program will perform the steps to obtain the purchase information and initiate the transmission of the information to the seller of the product or service so that the transaction can be completed.

In step 805, purchase information such as a shipping address and payment information, e.g. credit card number, is retrieved. The sensitive information can be stored in encrypted form for security purposes. Security measures such as using SSL can be used to make the transaction with the merchant or service provider secure. The purchase information can be stored in the terminal itself, in the set top box or in some other storage device that can be accessed. The purchase information can be transferred to the set box if it is not already stored there. Step 807 send the purchase information to the advertising data provider via the cable 111 of FIG. 1 or in a wireless manner. In an alternative embodiment, the remote display terminal can send the purchase information directly to the advertising data provider or its agent via a wireless method. In that case, the purchase information would need to be stored or entered in the remote display device. In some embodiments of the invention where the filtering of the advertisements occur at the set top box or the remote display terminal, the purchase information would not need to be send to an advertising data provider such as a cable operator.

Finally, in step 809, the advertising data provider preferably will send a confirmation message to the user to say that the purchase request was received and/or is being processed. In addition to making purchases in response to advertisements, the terminal's user can also do other activities such as complete surveys, give feedback on television shows, enter contests or other types of interactive activity.

While the present invention has been described with reference to the particular illustrative embodiments, it is not restricted to those embodiments. It is to be appreciated that those skilled in the art can change or modify the embodiments without departing from the scope and spirit of the invention.

For example, while advertising information has been discussed as the transmitted information, other data can be used such as public service announcements, e-mailed messages, or electronic bill presentment information. Thus, the user can be reminded to perform a task such as pay a bill online.

We claim:

1. A method for displaying current advertisements on a wireless terminal, wherein said terminal comprises a display, comprising the steps of:
retrieving information comprising advertisement data from a device coupled to a server;
activating said wireless terminal in response to an external stimulus; and
displaying said advertisement data on said terminal's display during at least a portion of said activation step.

2. The method of claim 1, wherein said displaying step is performed during the power up operation of said remote terminal.

3. The method of claim 2, where said external stimulus is a power switch being engaged.

4. The method of claim 1, wherein said displaying step is performed during the start up execution of a web browser.

5. The method of claim 4, wherein said external stimulus is data received from a keyboard.

6. The method of claim 4, wherein said external stimulus is data received from a computer mouse.

7. The method of claim 1, wherein said displaying step is performed during the reactivation of said terminal following an inactive period of said terminal while said terminal's power was on.

8. The method of claim 7, wherein said external stimulus is data received from a keyboard.

9. The method of claim 1, wherein said advertising data is selected for at least one user of said terminal.

10. The method of claim 9, wherein said selected advertisement data is responsive to data indicative of said terminal viewer's Internet usage history.

11. The method of claim 9, wherein said selected advertisement data is responsive to data indicative of said terminal viewer's personalized program menu.

12. The method of claim 9, wherein said selected advertisement data is responsive to data indicative of said terminal viewer's program viewing history.

13. The method of claim 9, wherein said advertising data is responsive to said terminal's usage of functions enabled on said terminal.

14. The method of claim 1, wherein said advertising data is displayed on at least a second display.

15. The method of claim 1, wherein said advertisement enables the interactive purchase of a product or service described in said advertising data.

16. A system for providing targeted advertisements to a wireless terminal, comprising:
a device that receives advertising data from a server computer and transmits said data to a remote terminal; and
at least one said remote terminal that displays said received advertising information concurrently;
wherein said advertising data is selected for at least one user of said remote terminal.

17. The system of claim 16, wherein said device comprises a set top box.

18. The system of claim 16, wherein said device comprises a satellite.

19. The system of claim 16, wherein said terminal displays said advertising data when said remote terminal's operating system is executing at least one instruction of a program unrelated to said display function.

20. The system of claim 16, further including a means for personalizing said advertisements responsive to said at least one user's interaction with said remote terminal.

21. A method for enabling targeted advertisements to be displayed on a wireless terminal comprising a display, comprising the steps of:
retrieving information comprising advertisement data from a remote device coupled to a server; and
displaying said advertisement data on said terminal's display when said terminal's operating system is concurrently executing at least one program instruction;
wherein said advertisement data is selected for at least one user of said terminal.

22. The method of claim 21, wherein said displaying step is performed during the power up operation of said remote terminal.

23. The method of claim 21, wherein said displaying step is performed during the start up execution of said web browser.

24. The method of claim 21, wherein said displaying step is performed during the reactivation of said terminal following an inactive period of said terminal while said terminal's power was on.

25. The method of claim 21, wherein said selected advertisement data is responsive to data indicative of said terminal viewer's Internet usage history.

26. The method of claim 21, wherein said selected advertisement data is responsive to data indicative of said terminal viewer's personalized program menu.

27. The method of claim 21, wherein said selected advertisement data is responsive to data indicative of said terminal viewer's program viewing history.

28. The method of claim 21, wherein said advertising data is responsive to said terminal's viewer usage of functions enabled on said terminal.

29. The method of claim 21, wherein said advertisement enables the interactive purchase of a product or service described in said advertising data.

30. A wireless terminal device comprising:
a receiver for receiving advertising data;
a processor that selects a portion of said advertising data responsive to at least one user of said device; and
a display for displaying said selected advertising data.

31. The device of claim 30, wherein said processor selection is responsive to said at least one user's interaction with said remote terminal.

32. The device of claim 30, wherein said terminal displays said advertising data when said remote terminal's operating system is executing at least one instruction of a program unrelated to said display function.

33. The device of claim 30, wherein said advertising data is displayed during at least a portion of an activation process in said terminal in response to an external stimuli.
